(19) United States
(12) Patent Application Publication
(10) Pub. No.: US 2008/0100870 A1
(43) Pub. Date: May 1, 2008

(54) Image Processor

(75) Inventors: Hiroaki Fujii, Nagoya-shi (JP); Hirofumi Oguri, Nagoya-shi (JP); Tatsuya Sato, Ichinomiya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Brother Kogyo Kabushiki Kaisha, Nagoya-shi (JP)

(21) Appl. No.: 11/929,384

(22) Filed: Oct. 30, 2007

(30) Foreign Application Priority Data
Oct. 31, 2006 (JP) 2006-297116

(51) Int. Cl. G06K 15/00

(52) U.S. Cl. 358/3.2

(57) ABSTRACT

There is disclosed an image processor including a display screen, a color image storage, a monochrome image storage, an image presenter, an image-area designator, a color-data replacer, and an outputter. The color image storage stores color image data constituted by a plurality of pieces of color data. The monochrome image storage stores monochrome image data obtained by converting the color image data and constituted by a plurality of pieces of color data. The image presenter can operate to present on the display screen a color image on the basis of the color image data stored in the color image storage, and a monochrome image on the basis of the monochrome image data stored in the monochrome image storage. The image-area designator can designate at least a part of at least one of the color image and the monochrome image that are presented on the display screen by the image presenter. The color-data replacer replaces one of the pieces of color data constituting the monochrome image data and corresponding to the part designated by the image-area designator, with another piece of color data. The outputter outputs the monochrome image data including the substituted piece of color data by the color-data replacer.

### CROSS REFERENCE TO RELATED APPLICATION

The present application claims priority from Japanese Patent Application No. 2006-297116, which was filed on Oct. 31, 2006, the disclosure of which is herein incorporated by reference in its entity.

### BACKGROUND OF THE INVENTION

1. Field of the Invention

The present invention relates to an image processor, and particularly to an image processor which prevents that when color image data is outputted as a monochrome image, the outputted monochrome image becomes unrecognizable or difficult to recognize.

2. Description of Related Art

When a facsimile machine receives data of a color image (hereinafter referred to as “color image data”), and prints out the image in monochrome, it may occur that the image is recognizable when in color but becomes unrecognizable or difficult to recognize when printed out in monochrome.

JP-A-10-155085 discloses an apparatus that divides a color image into a plurality of parts such that each part is constituted by pixels of a same or similar color, and then converts the color image into a monochrome image by converting the parts into respectively corresponding textures, thereby preventing the obtained monochrome image from being unrecognizable.

JP-A-2003-283848 discloses an apparatus that outputs color image data as a monochrome image by separating between characters or text and a background thereof, and when the contrast or difference in luminance between the text and the background is relatively small, changing the luminance of one of the text and the background, in order to make the monochrome image recognizable.

However, both of the above-described apparatuses have a drawback that when color image data is transmitted to a facsimile machine to be printed out thereby as a monochrome image, how the monochrome image will appear when printed out is unknown, that is, which part of the image will become unrecognizable or difficult to recognize when outputted as a monochrome image is unknown until the image is actually received and printed out by the facsimile machine at the receiving side.

When the above-described techniques are applied to a printer, a similar problem occurs, that is, when the printer is to print a monochrome image on the basis of color image data, it is unknown how the printed monochrome image will appear.

### SUMMARY OF THE INVENTION

This invention has been developed in view of the above-described situations, and it is an object of the invention, therefore, to provide an image processor that can prevent that when color image data is outputted as a monochrome image, the outputted monochrome image becomes unrecognizable or difficult to recognize.

To attain the above object, the invention provides an image processor including a display screen, a color image storage, a monochrome image storage, an image presenter, an image-area designator, a color-data replacer, and an outputter. The color image storage stores color image data constituted by a plurality of pieces of color data. The monochrome image storage stores monochrome image data obtained by converting the color image data and constituted by a plurality of pieces of color data. The image presenter can operate to present on the display screen a color image on the basis of the color image data stored in the color image storage, and a monochrome image on the basis of the monochrome image data stored in the monochrome image storage. The image-area designator can designate at least a part of at least one of the color image and the monochrome image that are presented on the display screen by the image presenter. The color-data replacer replaces one of the pieces of color data constituting the monochrome image data and corresponding to the part designated by the image-area designator, with another piece of color data. The outputter outputs the monochrome image data including the substituted piece of color data by the color-data replacer.

The image presenter can present both the color image and the monochrome image, but it is not essential that the image presenter can present the color image and the monochrome image at a time.

The image-area designator can designate at least a part of at least one of the color image and the monochrome image. Thus, the image-area designator may be capable of designating at least a part of both the color image and the monochrome image. In the case where the image-area designator can designate at least a part of both the color image and the monochrome image, it may be arranged such that one of the color image and the monochrome image is first selected, and then a part of the selected image is designated. Where the image-area designator designates the part in the above-described way, that is, first selecting one of the color image and the monochrome image and then designating a part of the selected image, the image-area designator may further has a function such that upon the designation of the part of the one of the color and monochrome images, the corresponding part in the other of the color and monochrome images is also automatically designated.

The outputter can output the monochrome image data to at least one apparatus or device other than the image presenter, such as printer and facsimile machine.

In this image processor, the image presenter presents on the display screen the color image based on the color image data stored in the color image storage, and the monochrome image based on the monochrome image data stored in the monochrome image storage. The image-area designator designates at least a part of the color and monochrome images presented by the image presenter. The color-data replacer replaces the piece of color data constituting the monochrome image data and corresponding to the part designated by the image-area designator. The outputter outputs the monochrome image data including the substituted piece of color data by the color-data replacer.

Hence, before the monochrome image obtained on the basis of the color image is outputted, a user can view and compare the color image and the monochrome image on the display screen, and thus can easily find a part that is recognizable in the color image but difficult to recognize or unrecognizable in the monochrome image. The user designates the part difficult to recognize or unrecognizable, in order to replace the piece of color data corresponding to the part to make the part recognizable even in the monochrome image. Therefore, when a facsimile machine receives monochrome image data from another facsimile machine including the image processor and prints out a monochrome image on the basis of the monochrome image data, or when the image processor is applied to a printer to print out a monochrome image by converting color image data into monochrome image data, it is prevented that a part difficult to recognize or unrecognizable occurs in the outputted monochrome image although an entirety of the color image is recognizable.

The invention also provides an image processor including a display screen, a color image storage, a monochrome image storage, an image presenter, an image-area designator, a first color-data replacer, and a second color-data replacer, and an outputter. The color image storage stores color image data constituted by a plurality of pieces of color data. The monochrome image storage stores monochrome image data obtained by converting the color image data and constituted by a plurality of pieces of color data. The image presenter can operate to present on the display screen a color image on the basis of the color image data stored in the color image storage, and a monochrome image on the basis of the monochrome image data stored in the monochrome image storage. The image-area designator can designate at least a part of at least one of the color image and the monochrome image that are presented on the display screen by the image presenter. The first color-data replacer replaces one of the pieces of color data constituting the one of the monochrome image and the color image and corresponding to the part designated by the image-area designator, with another piece of color data. The second color-data replacer replaces one of the pieces of color data constituting the other of the monochrome image and the color image and corresponding to the designated part, upon the replacement of the piece of color data by the first color-data replacer. The outputter outputs at least one of the image data which includes the piece of color data substituted by the first color-data replacer, and the image data which includes the piece of color data substituted by the second color-data replacer.

In this image processor, the image presenter presents on the display screen the color image based on the color image data stored in the color image storage and the monochrome image based on the monochrome image data stored in the monochrome image storage, and the image-area designator designates at least a part of the color image or the monochrome image presented by the image presenter. The first color-data replacer replaces the piece of color data constituting one of the color image data and the monochrome image data and corresponding to the part designated by the image-area designator. Upon the replacement of the piece of color data by the first color-data replacer, the second color-data replacer also replaces the piece of color data constituting the other of the color image data and the monochrome image data and corresponding to the designated part. The outputter outputs the image data which is of color or monochrome and includes the piece of color data substituted by the first color-data replacer and/or the image data which is of the other of color and monochrome and includes the piece of color data substituted by the second color-data replacer.

Hence, before the color image and/or the monochrome image is outputted, a user can view and compare the color image and the monochrome image on the display screen, and thus can easily find a part that is recognizable in the color image but difficult to recognize or unrecognizable in the monochrome image. The user designates the part difficult to recognize or unrecognizable, in order to replace the piece of color data at the part to make the part recognizable even in the monochrome image. Therefore, when a facsimile machine which receives image data from another facsimile machine including the image processor is constructed to receive color image data and print out a monochrome image on the basis of the color image data, or receive monochrome image data and print out a monochrome image on the basis of the monochrome image data, it is prevented that a part difficult to recognize or unrecognizable occurs in the outputted monochrome image although an entirety of the image is recognizable when in color, that is before sent.

### BRIEF DESCRIPTION OF THE DRAWINGS

The above and other objects, features, advantages and technical and industrial significance of the present invention will be better understood by reading the following detailed description of preferred embodiments of the invention, when considered in connection with the accompanying drawings, in which:

FIG. 1 is an external perspective view of a multifunction peripheral including an image processor according to a first embodiment of the invention;

FIG. 2 is a block diagram showing an electrical structure of the multifunction peripheral;

FIG. 3A is a view of a display screen on which an image is presented both in color and in monochrome, and FIG. 3B is another view of the display screen in which the monochrome image is altered;

FIG. 4A is a view where a plurality of pages of a document are presented on the display screen, FIG. 4B is a view where a second page of the document is presented in a normal mode, and FIG. 4C is a view where the pages of the document is presented on the display screen in a thumbnail mode, with the second page being currently selected;

FIGS. 5A-5B show a flowchart according to which an image processing of the first embodiment is implemented;

FIG. 6 shows a part of a flowchart according to which an image processing of a second embodiment is implemented, which part is different from the image processing of the first embodiment;

FIG. 7 shows a part of a flowchart according to which an image processing of a third embodiment is implemented, which part is different from the image processing of the second embodiment;

FIG. 8 shows a part of a flowchart according to which an image processing of a fourth embodiment is implemented, which part is different from the image processing of the first embodiment; and

FIG. 9 shows a part of a flowchart according to which an image processing of a fifth embodiment is implemented, which part is different from the image processing of the first embodiment.

### DETAILED DESCRIPTION OF PREFERRED EMBODIMENTS

Hereinafter, there will be described presently preferred embodiments of the invention, by referring to the accompanying drawings.

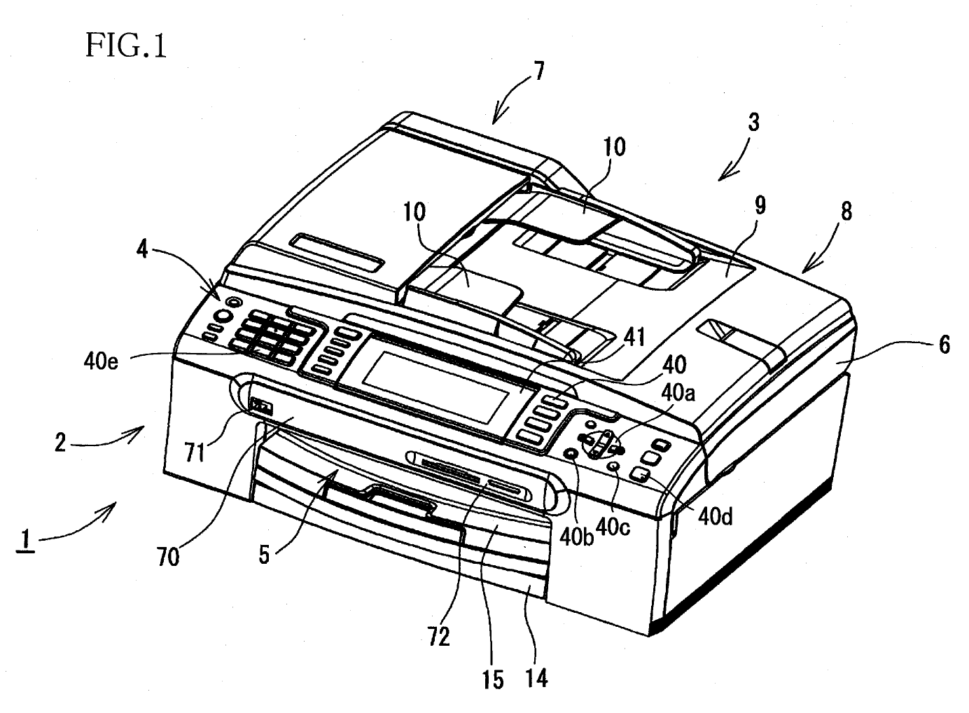

Referring first to FIGS. 1-5, there will be described a first embodiment of the invention in the form of a multifunction peripheral. FIG. 1 is an external perspective view of the multifunction peripheral which will be hereinafter abbreviated to MFP 1. The MFP 1 integrally includes a printer portion 2, a scanner portion 3, and an operation panel 4. The printer portion 2 and the scanner portion 3 respectively constitute a lower portion and an upper portion of the MFP 1. The operation panel 4 is disposed on the front side of the scanner portion 3. The MFP 1 has a printer function, a scanner function, and a facsimile function.

The MFP 1 can be connected to a computer (not shown) to receive therefrom data of an image or document and record the image or document on a recording medium such as a cut sheet of paper, based on the data. The MFP 1 can also be connected to an external device such as digital camera to receive therefrom data of an image and record the image on a recording medium. Further, various kinds of storage media such as memory card are insertable into the MFP 1 to provide data of an image stored therein to the MFP 1 so that the MFP can record the image on a recording medium based on the data. The recording medium, on which an image or others is recorded, may be a transparent film for OHP or a cloth.

The scanner portion 3 includes a document reading table 6 and a document cover 8 that is attached to the document reading table 6 to be openable/closable relative to the document reading table 6, that is, the document cover 8 is turnable around a hinge disposed at the back side of the document reading table 6. The reading table 6 functions as a FBS (Flatbed Scanner). The document cover 8 includes an automatic document feeder (hereinafter referred to as ADF) 7.

The upper side of the document reading table 6 is wide open, and a platen glass is disposed to close this opening. Inside the document reading table 6, an image reading unit, a member supporting the image reading unit, and a mechanism for moving the image reading unit are disposed such that the image reading unit is movable inside the document reading table 6.

The ADF 7 feeds a plurality of document sheets one by one along a feed path starting at a document tray 9 and ending at a document catch tray 10. The printer portion 2 is an inkjet type image recording apparatus that records an image on a recording medium by selectively ejecting ink droplets on the basis of image data, which is read by the scanner portion 3 or inputted from an external device. The printer portion 2 is disposed under the scanner portion 3.

At the front side of the printer portion 2, there is formed an opening 5 into which a medium supply tray 14 and a medium catch tray 15 are insertable to be completely accommodated. These trays 14 and tray 15 are arranged in vertical relation, that is, the medium catch tray 15 is disposed over the medium supply tray 14.

As FIG. 1 shows, the operation panel 4, which is laterally long, is disposed at a front side of the MFP 1. A dimension of the operation panel 4 in a front-rear direction is equal to or smaller than a difference between dimensions of the printer portion 2 and the scanner portion 3 in the same direction. The operation panel 4 includes various kinds of operation keys 40 and a display screen 41, and a user can operate the printer potion 2 and the scanner portion 3 through manipulation of the operation keys 40. In the first embodiment, the display screen 41 is a LCD (Liquid Crystal Display) and is constituted by two segments, in other words, two sub screens are laterally arranged in the display screen 41. An aspect ratio of each of the sub screens is 3:4, and an aspect ratio of the whole display screen 41 is 3:8.

The user can input a command or instruction through the operation panel 4. When an instruction is inputted into the MFP 1, operation of the MFP 1 is controlled by a control unit 20 on the basis of the inputted information or instruction. The operation keys 40 disposed in the operation panel 4 include a crisscross key 40a, a function switch key 40b, an enter key 40c, an output start key 40d, and a numeric keypad 40e. The crisscross key 40a includes a left arrow key portion, a right arrow key portion, an up arrow key portion, and a down arrow key portion, that are arranged around a central portion of the crisscross key 40a and equiangularly spaced from one another to be individually manipulatable. The function switch key 40b is manipulated mainly when the function of the crisscross key 40a is to be switched. The enter key 40c is manipulated mainly when a currently selected option is to be activated. The output start key 40d is manipulated when printing or facsimile transmission is to be started. The numeric keypad 40e is disposed to the left of the display screen 41 and manipulated when numerals 0 to 9 are to be inputted.

The MFP 1 is operated on the basis of an instruction that may be inputted through the operation panel 4. When the MFP 1 is connected to a computer, the MFP 1 can be operated on the basis of an instruction transmitted from the computer via a printer driver or a scanner driver.

On the upper side of the opening 5 in the printer portion 2, a connector panel 70 is disposed. In a left end portion in the connector panel 70, a USB terminal 71 is disposed. The USB terminal 71 is a connector terminal for USB-connection between the MFP 1 and an external device that enables communication therebetween. In a right end portion of the connector panel 70, a slot portion 72 is disposed. The slot portion 72 has a plurality of card slots into which card-type storage media are insertable. The control unit 20 (described in detail later) operates to read data of an image or images from a card-type storage medium inserted in one of the slots, and display the image(s) and/or information related to the image(s) on the display screen 41, or alternatively, record a selected one of a plurality of images on a recording medium by means of the printer portion 2.

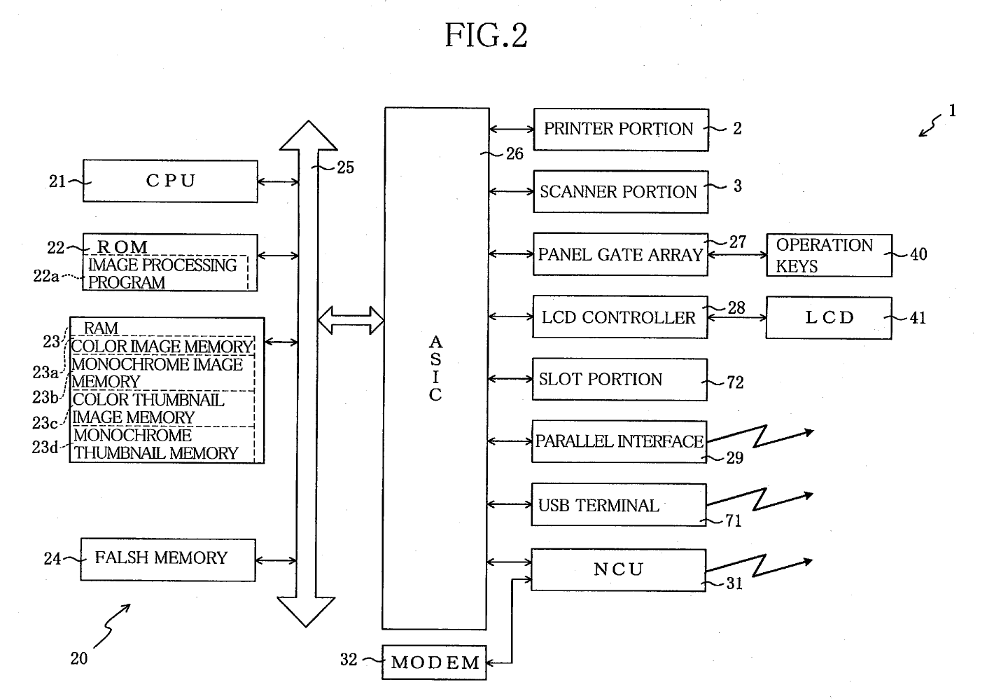

There will be described a general electrical structure of the MFP 1, with reference to a block diagram of FIG. 2. The control unit 20 generally controls operation of the MFP 1 including operations of the printer portion 2, the scanner portion 3, and the operation panel 4. As shown in FIG. 2, the control unit 20 is constituted by a microcomputer mainly composed of a central processing unit (CPU) 21, a read only memory (ROM) 22, a random access memory (RAM) 23, and a flash memory 24, and is connected to an application specific integrated circuit (ASIC) 26 via a bus 25.

The ROM 22 stores various kinds of control programs and constants and tables that are used in the control programs. The control programs include programs according to which the facsimile and scanner functions and a copy function and a trim function are respectively controlled.

The RAM 23 is a randomly accessible memory that temporarily stores variables and parameters when the CPU 21 implements various operations. The RAM 23 includes a color image memory 23a that stores color image data, i.e., data of a color image, which is read by the scanner portion 3 when facsimile transmission or copy printing is to be implemented.

When a color image is displayed on the display screen 41 on the basis of color image data stored in the color image memory 23a, a monochrome image obtained by converting the color image is presented as well as the color image. Viewing the monochrome image, the user may judge that the monochrome image includes a part difficult to recognize or unrecognizable. Where the user judges that the monochrome image includes such a part, the user specifies or designates the part difficult to recognize or unrecognizable, in the color image. That is, the color image is constituted by a plurality of pieces of color data representing respective colors, and the user designating the part difficult or impossible to recognize specifies one of the pieces of color data that constitutes the part difficult or impossible to recognize. The thus specified piece of color data is replaced with, or substituted by, another piece of color data. The MFP 1 alters the monochrome image presented on the display screen 41 according to the thus substituted piece of color data. Upon determination of which piece of color data is to be substituted by which piece of color data, the substituting piece of color data is stored in the RAM 23.

The ROM 22 stores an image processing program 22a, according to which an image is presented both in color and in monochrome on the display screen 41 on the basis of color image data stored in the color image memory 23a and in response to manipulation of the operation keys 40 by the user. According to the image processing program 22a, upon the user inputting through the operation keys 40 an instruction to replace any piece of color data in the color image, the piece of color data is accordingly replaced and the monochrome image presented on the display screen is altered in accordance with the replacement of the piece of color data.

The ASIC 26 controls operations of the printer portion 2, the scanner portion 3, the operation panel 4, and the slot portion 72, on the basis of an instruction from the CPU 21. The control of operations of the printer portion 2, the scanner portion 3, and the slot portion 72 is not described in detail, but in brief, the control unit 20 controls operations of a motor for driving the printer portion 2, an inkjet recording head, a motor for driving the scanner portion 3, the image reading unit, and of others.

To the ASIC 26 is connected a panel gate array 27 that implements operation related to the operation keys 40 through which the user inputs an instruction he/she desires into the MFP 1. The panel gate array 27 detects the user pressing down any of the operation keys 40 and outputs a code signal corresponding to the pressed key. That is, codes are assigned to the respective operation keys 40 and the panel gate array 27 outputs a signal representing the code assigned to the pressed key. The CPU 21 receives the code signal from the panel gate array 27, and implements a control processing that is determined in accordance with a predetermined key processing table. The key processing table defines correspondence between each code and a control processing to be implemented upon pressing down of the key associated with the code, and may be stored in the ROM 22, for instance.

To the ASIC 26 is also connected a LCD controller 28 that controls presentation of information or image on the display screen 41. In response to an instruction from the CPU 21, the LCD controller 28 makes the display screen 41 present information related to an operation of the printer portion 2 or scanner portion 3, or an image that is read or inputted.

The display screen 41 has a matrix of switches (not shown) operating in accordance with RGB signals. Three switches for three sub pixels of the three primitive colors, i.e., red, green, and blue, correspond to one dot in a dot matrix of the display screen 41. By selectively applying or not applying an electrical charge in the form of a RGB signal to each of the switches, liquid crystal molecules right under each switch are oriented in a manner to let light pass through or block light, thereby enabling to make one of the three primitive colors appear at a dot on the display screen 41.

The LCD controller 28 scans, in a predetermined cycle, values for RGB stored in a display memory (not shown), and applies a voltage to each switch corresponding to a bit whose value is “1”. To the ASIC 26 are connected a parallel interface 29 and the USB terminal 71. The parallel interface 29 enables data communication between the MFP 1 and a computer via a parallel cable. Further, a network control unit (NCU) 31 is connected to the ASIC 26. A modem 32 is connected to the NCU 31 and the NCU 31 enables the facsimile function.

As described above, the slot portion 72 has a plurality of card slots into which card-type storage media or memories are insertable. When a card-type memory is inserted in one of the card slots, and the control unit 20 (described later) reads data of an image or images from the card-type memory, the control unit 20 operates to present on the display screen 41 the image(s) read and/or information related to the image(s), or alternatively, records a desired one of a plurality of images on a recording medium by means of the printer portion 2.

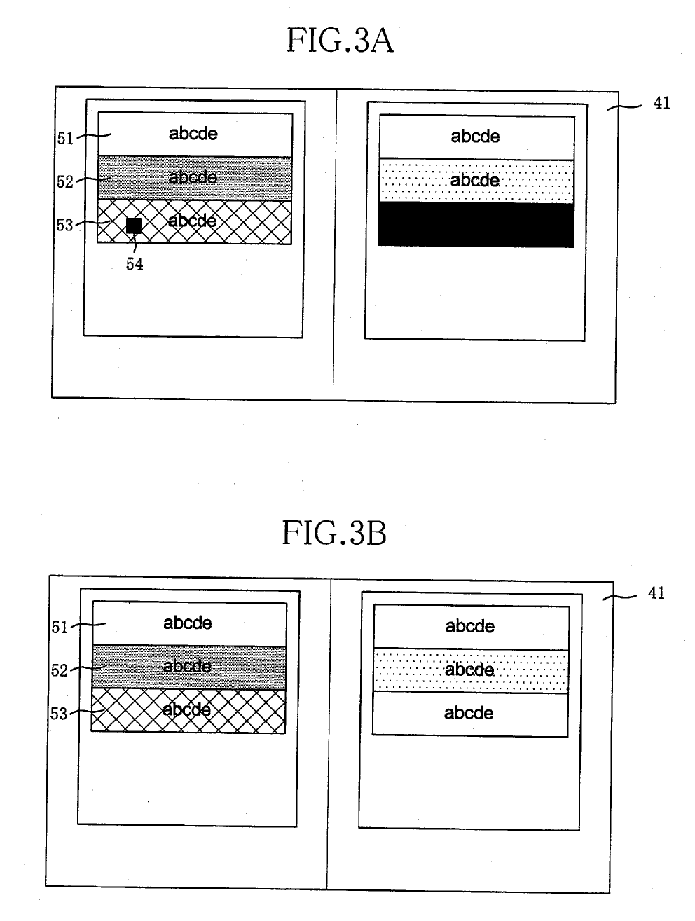

There will be described how image is presented on the display screen 41. By referring to FIGS. 3A and 3B, there will be first described how the display screen 41 appears in a normal mode, in a case where the image data read and to be processed is of one page.

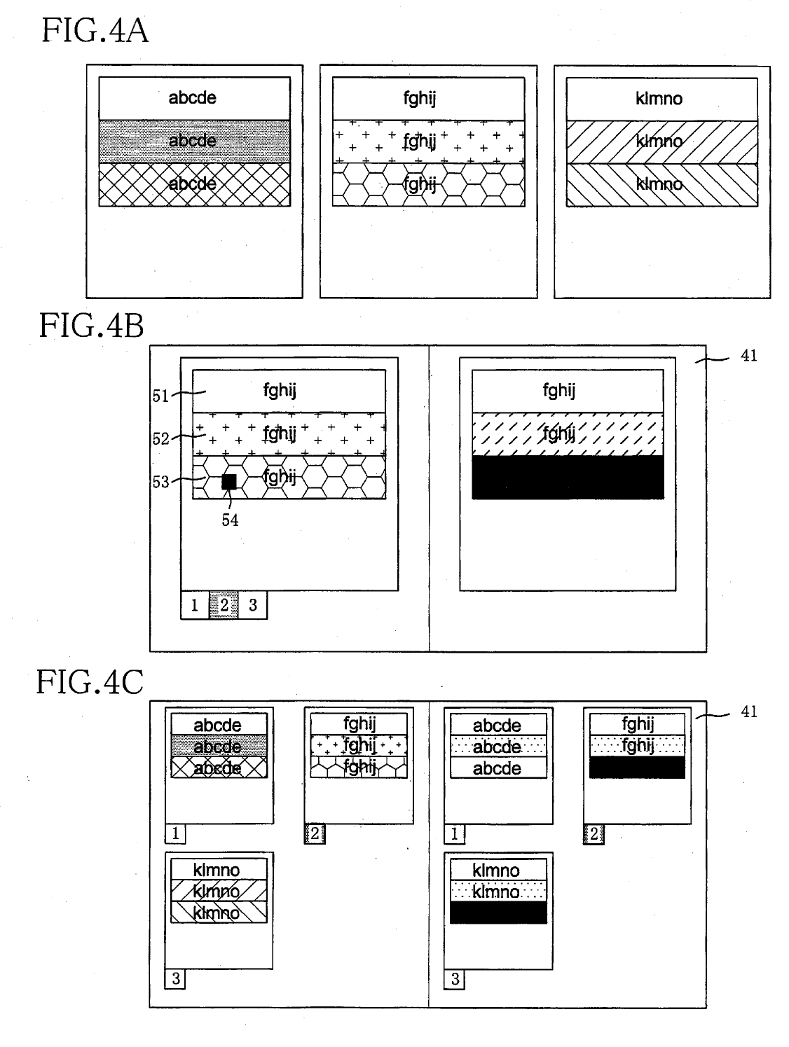

That is, the display mode of the display screen 41 is switchable between a normal mode and a thumbnail mode, in the latter of which, images of a plurality of pages can be presented at a time. Hence, the display screen 41 is placed in the latter mode when the image data to be processed is of a plurality of pages. The thumbnail mode will be described later with reference to FIGS. 4A-4C.

When the MFP 1 is operated to read a color image by means of the scanner portion 3 and then implements facsimile transmission or copy printing, the read color image Iand a monochrome image are first presented at left and at right, respectively, on the display screen 41. The monochrome image is obtained by converting the color image and presented to be contrasted or compared with the original color image in order that the user can check whether the color image includes a part that will be difficult or impossible to recognize when printed in monochrome.

Where a part difficult or impossible to recognize is included in the monochrome image presented on the display screen 41, the user inputs an instruction to change the color of the part.

In the normal mode, the display screen 41, which is rectangular, is segmented into two longitudinal halves, and the two halves or segments provide two sub screens of a same size. The left one of the sub screens is for presenting a color image, and the right one for presenting a monochrome image obtained by converting the color image.

In an example of FIGS. 3A and 3B, an image of one page that has three areas (i.e., an upper area, a middle area, and a lower area) 51, 52, 53 of different colors is presented. The areas 51-53 are lettered in the same way. More specifically, background colors of the areas 51-53 are different from one another, and a same letter string “abcde” in black are put in each of the areas 51-53. In a color image a character or a letter put on a background is recognizable even where the background color is relatively dark or deep. However, when the color image is converted and presented as a monochrome image, the character or letter becomes difficult or impossible to recognize on the background of the relatively dark or deep color.

The user moves a cursor 54, which is presented on the color image, to an area where the letter string is difficult to recognize in the monochrome image, in order to instruct to change the background color in the area. An instruction to move the cursor 54 is inputted by manipulation of the crisscross key 40a disposed in the operation panel 4, and an instruction to change the background color is inputted by manipulation or pressing of the enter key 40c.

The FIG. 3A shows the display screen 41 before input of the instruction to change the background color. In FIG. 3A, the background colors of the areas 51, 52, 53 in the color image are white, pale blue, and blue, respectively. It is noted that in FIGS. 3A-4C, patterns such as mesh pattern are used to represent the difference in background color among the areas 51-53 in each image since it is impossible to directly represent colors in the drawings.

In the monochrome image, on the other hand, background colors of the areas 51, 52 are relatively light and the letter string “abcde” in these areas 51, 52 is recognizable. However, a background color of the area 53 in the monochrome image is so dark that the letter string “abcde” is unrecognizable. Hence, the user moves the cursor 54 to the area 53 in the color image.

In this state, the user inputs an instruction to change the background color of the area 53 in the monochrome image, for instance, to white. FIG. 3B shows the state in which the background color of the area 53 is changed to white in the monochrome image. The changing the background color of the area 53 in the monochrome image makes recognizable the letter string in the area 53 in the monochrome image. Hence, the user can rest assured that when the data of the thus changed monochrome image is sent thereafter by facsimile transmission to a facsimile machine and the facsimile machine prints out a monochrome image on the basis of the received monochrome image data, the letter string in the area 53 will be recognizable and easily legible in the printed monochrome image.

There will be described the thumbnail mode, with reference to FIGS. 4A-4C. A switch between the two display modes, namely, the normal mode and the thumbnail mode, is made by pressing down the up or down arrow key portion of the crisscross key 40a. That is, when one of the up and down arrow key portions is pressed down while the display screen 41 is in the normal mode, the display mode is switched to the thumbnail mode. On the other hand, when one of the up and down arrow key portions is pressed down while the display screen 41 is in the thumbnail mode, the display mode is switched to the normal mode.

FIGS. 4A-4C shows the display screen 41 in a case where images of three pages are read and presented on the display screen 41. FIG. 4A shows the state where the three pages are presented on the display screen 41. An image of a first page includes an upper, a middle, and a lower area 51, 52, 53 each of which is lettered “abcde”, like the case of FIGS. 3A and 3B. An image of a second page also includes such three areas 51-53, but each of which is lettered “fghij”. An image of a third page includes similar three areas 51-53, but each of which is lettered “klmno”. In each page, background colors of the areas 51-53 are different from one another. In FIGS. 4A-4C, the difference in background color among the areas 51-53 is represented by differentiating texture patterns of the areas 51-53.

FIG. 4B shows the state where the second page is selectively presented on the display screen 41 in the normal mode. Like the case of FIGS. 3A and 3B, a color image is presented at the left one of the two sub screens of the display screen 41, and a monochrome image obtained by converting the color image is presented at the right sub screen. In the second page, the areas 51-53 that are different in background color are lettered in the same way, namely, a letter string “fghij” in black is put on each area 51-53. The cursor 54 is located in the area 53.

At a lower side of the color image at left of the display screen 41, tabs providing page numbers are presented. That is, in FIG. 4B, three tabs for the respective three pages are presented, and a background color of one of the tabs that is numbered “2” is slightly dark, thereby indicating that the page currently selectively presented on the display screen 41 is the second page. Each time the left arrow key portion of the crisscross key 40a is pressed down, the currently selected tab shifts to left by one, that is, the number of the currently selected page decrements by one, and each time the right arrow key portion of the crisscross key 40a is pressed down, the currently selected tab shifts to right, that is, the number of the currently selected page increments by one.

When the function switch key 40b is pressed down, the cursor 54 becomes movable up, down, leftward, and rightward by manipulation of the four key portions of the crisscross key 40a. When the function switch key 40b is again pressed down, it becomes possible to select the tabs by manipulating the left and right arrow key portions, and to switch the display mode by manipulating the up and down arrow key portions.

FIG. 4C shows the display screen 41 in the thumbnail mode. On the left sub screen in the display screen 41, color images of the three pages are presented in a reduced size, with the tabs of the pages presented under the respective images. Similarly, on the right sub screen in the display screen 41, monochrome images of the three pages are presented in the same reduced size as the color images, with the tabs of the pages presented under the respective images.

As shown in FIG. 4C, when the second page is selected, the tab of the second page is represented such that the background color of the tab is darker than that of the other tabs in both the color and monochrome images, thereby indicating that the second page is currently selected. When the display mode is switched from thumbnail to normal in this state, the second page is presented in the normal mode since the second page is currently selected.

Presenting images of a plurality of pages in the thumbnail mode is advantageous in that the user can view a plurality of images at a time to check whether there is a part that is difficult or impossible to recognize when the images are presented in monochrome, while comparison among the pages is allowed.

The area difficult or impossible to recognize can be designated or specified in the thumbnail mode also, by moving the cursor 54. When an instruction to change the background color is inputted, the corresponding monochrome image is altered such that the background color of the area in question is changed to white.

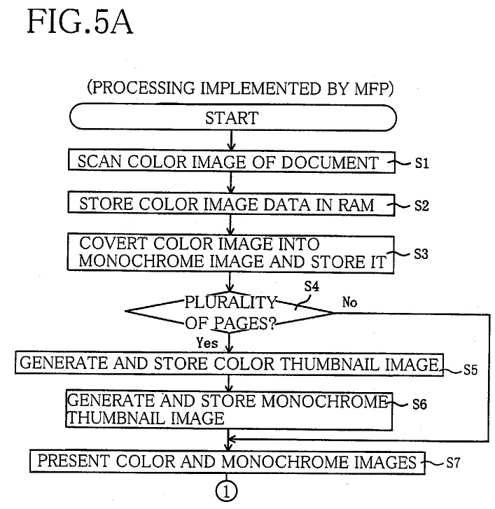

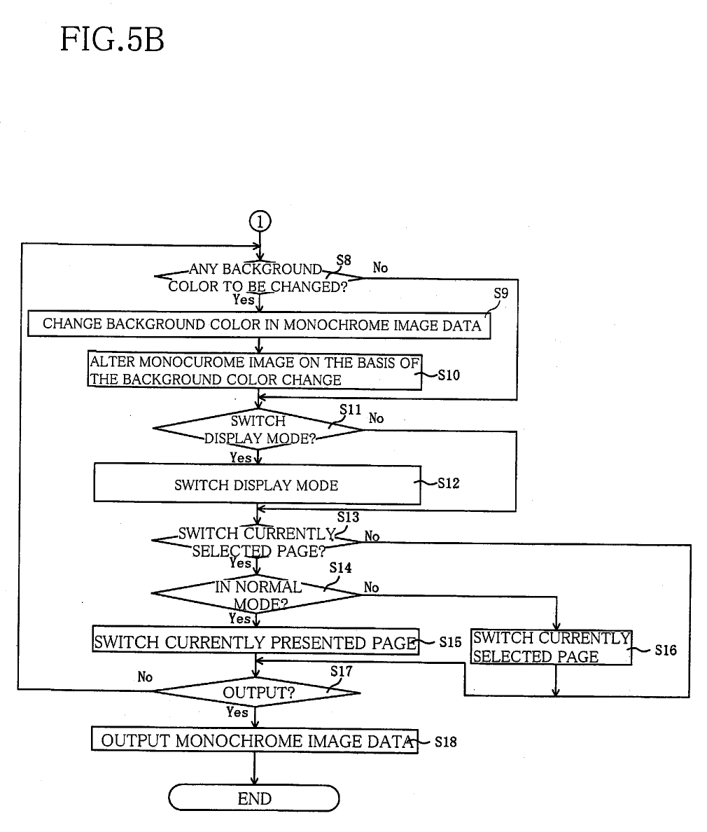

An image processing implemented by the CPU 21 will be described with reference to a flowchart of FIGS. 5A-5C. This image processing is implemented in a case where the user wishes to send a color image to a facsimile machine by facsimile transmission, and the facsimile machine can receive only monochrome images. Briefly described, first, a color image is read in, and data of the color image (which may be referred to as the “color image data”) is stored in the RAM. The color image is presented at the left half or on the left sub screen of the display screen 41 on the basis of the color image data stored in the RAM. The color image data is also converted into data of a monochrome image (which may be referred to as the “monochrome image data”), and the monochrome image is presented at the right half or on the right sub screen of the display screen 41 on the basis of the monochrome image data.

The user views the presented color and monochrome images and checks whether there is a part difficult or impossible to recognize in the monochrome image. When there is a part difficult or impossible to recognize in the monochrome image, the user instructs to change the color thereat and the CPU 21 implements a processing to change the color accordingly.

The processing to change the color of the part difficult or impossible to recognize in the monochrome image will be described in more detail along the flowchart. The processing begins with step S1 in which a color document is scanned to obtain data of a color image of the document. In the next step S2, the color image data of the document is stored in the color image memory 23a. When the document consists of a plurality of pages, the pages are one by one scanned and color image data of each page thus obtained is stored in the color image memory 23a. Then, the processing flow goes to step S3 in which the color image stored is converted into a monochrome image, which is stored in a monochrome image memory 23b included in the RAM 23. In the case where the document consists of a plurality of pages, the color image data of the pages are one by one converted into monochrome image data, which are stored in the monochrome image memory 23b.

The processing flow then goes to step S4 in which it is determined whether the document read consists of a plurality of pages. When an affirmative decision (YES) is obtained in step S4, the processing flow goes to step S5 in which a color thumbnail image is generated for each of the pages by reducing the size of the color image, data of which is stored in the color image memory 23a, and the generated thumbnail image is stored in a color thumbnail image memory 23c included in the RAM 23. Then, the processing flow goes to step S6 in which the color thumbnail images stored in the color thumbnail image memory 23c are respectively converted into monochrome thumbnail images, and data of the monochrome thumbnail images thus obtained are stored page by page in a monochrome thumbnail image memory 23d included in the RAM 23. As a method to reduce the size of the images, there is employed average pixel method, nearest neighbor method, or bi-linear method.

The processing flow then goes to step S7 in which the color image stored in the color image memory 23a is presented at the left sub screen of the display screen 41, and the monochrome image stored in the monochrome image memory 23b is presented at the right sub screen of the display screen 41. In the case where the document consists of a plurality of pages, the color and monochrome images of the first page are presented. Images are presented in this way since the currently selected display mode is the normal mode.

Then, the processing flow goes to step S8 in which it is determined whether the user manipulates the enter key 40c to input an instruction to change the background color of an area after moving the cursor 54 to designate the area. Although not shown, while a designating function (i.e., a function to specify or designate a particular area in an image on the display screen 41, by the user placing the cursor on the area) is enabled, the CPU 21 operates to change the position of the cursor 54 upon and according to a manipulation of the crisscross key 40a by the user.

When an affirmative decision (YES) is obtained in step S8, namely, when it is determined that the enter key 40c is manipulated, the processing flow goes to step S9 in which the monochrome image data is altered such that a piece of color data constituting the designated area or background is replaced to another piece of color data representing a white color. In the next step S10 the monochrome image presented on the display screen 41 is altered accordingly. In step S9, only the monochrome image data stored in the monochrome image memory 23b is altered, and the color image data stored in the color image memory 23a is not altered.

In the case where the display screen 41 is in the thumbnail mode, the user can designate an area the background color at which is to be changed, by moving the cursor 54 on the thumbnail images. When any area whose background color is to be changed is designated in the thumbnail mode, the monochrome image data stored in the monochrome image memory 23b is altered accordingly, and then the thumbnail monochrome image presented on the display screen 41 is accordingly altered.

When the processing of step S10 is complete, or when a negative decision (NO) is obtained (i.e., when it is determined that the enter key 40c is not manipulated by the user) in step S8, the processing flow goes to step S11 in which it is determined whether an instruction to switch the display mode from one of the normal and thumbnail modes to the other is inputted. As described above, it is preset such that after the function switch key 40b is manipulated to enable input of the instruction to switch the display mode, the user can actually input an instruction to switch the display mode, by pressing down the up arrow portion or the down arrow portion of the crisscross key 40a.

When the user inputs the instruction to switch the display mode in step S11, the display mode is switched in step S12, that is, when the currently selected display mode is the normal mode, the display mode is switched to the thumbnail mode, and when the currently selected display mode is the thumbnail mode, the display mode is switched to the normal mode.

When the processing of step S12 is complete, or when a negative decision (NO) is made (i.e., when the instruction to switch the display mode is not inputted) in step S11, the processing flow goes to step S13 in which it is determined whether an instruction to switch the currently selected page is inputted. It is preset such that after the function switch key 40b is manipulated to enable input of the instruction to switch the currently selected page, the user can actually input the instruction to switch the currently selected page by pressing down the left arrow portion or the right arrow portion of the crisscross key 40a.

When an affirmative decision (YES) is made (i.e., when it is determined that the instruction to switch the currently selected page is inputted) in step S13, the processing flow goes to step S14 in which it is determined whether the currently selected display mode is the normal mode. When an affirmative decision (YES) is made (i.e., when it is determined that the currently selected display mode is the normal mode) in step S14, the processing flow goes to step S15 in which the presented color and monochrome images are replaced with a color image and a monochrome image of the page that is selected in step S13. On the other hand, when a negative decision (NO) is obtained (i.e., when it is determined that the currently selected display mode is the thumbnail mode) in step S14, the processing flow goes to step S16 in which the presentation of the tabs is altered to reflect the switch in the currently selected page.

When the processing of step S15 or S16 is complete, or when a negative decision (NO) is obtained (i.e., it is determined that the instruction to switch the currently selected page is not inputted) in step S13, the processing flow goes to step S17 in which it is determined whether an instruction to output an image, namely, start facsimile transmission, is inputted. When a negative decision (NO) is made (i.e., when it is determined that the instruction to start facsimile transmission is not inputted) in step S17, the processing flow returns to step S8. On the other hand, when an affirmative decision (YES) is made (i.e., when it is determined that the instruction to start facsimile transmission is inputted) in step S17, the processing flow goes to step S18 in which the monochrome image data stored in the monochrome image memory 23b is outputted or sent out by facsimile transmission and the current cycle of the image processing is terminated. The instruction to start the output or facsimile transmission is inputted by manipulation of the output start key 40d.

As described above, according to the first embodiment of the invention, a color image or images of a document read and a monochrome image or images obtained by converting the color image(s) are presented on the respective sub screens that are formed as two halves of the display screen 41.

At this time, the user can view the color and monochrome images at a time and easily compare the color and monochrome images, and thus the part that is recognizable in color but difficult or impossible to recognize in monochrome is easily found. That is, it is easy to find a part that will be unrecognizable or difficult to recognize when a color image is outputted in monochrome. In addition, this arrangement of the display screen 41 also facilitates the manipulation by the user to designate the part, since the user can designate the part while viewing and comparing the color and monochrome images. Further, since the sub screens are arranged adjacent to each other, the user can further easily compare the color and monochrome images, thereby further facilitating the manipulation to designate the part difficult or impossible to recognize in monochrome. Still further, since the two sub screens have a same size, the user can easily view and compare the color and monochrome images presented on the respective sub screens. The color and monochrome images are presented in one of the normal and thumbnail modes, in each of which a color image and a corresponding monochrome image are presented in a same size. Namely, in the normal mode, one color image and one monochrome image obtained by converting the color image are presented at a time and in a same size. In the thumbnail mode, a plurality of color thumbnail images and a plurality of monochrome thumbnail images corresponding to the color thumbnail images are presented at a time such that all the thumbnail images have a same size. Hence, the viewing and comparing the color and monochrome images and the manipulation to designate the part difficult or impossible to recognize are further facilitated.

The user then views the altered monochrome image to check or confirm that now there is included no parts difficult or impossible to recognize. Thereafter, the user starts transmission of the monochrome image. Thus, in the case where the user desires to send an image that is originally in color, to a facsimile machine that receives only monochrome images, the user can rest assured that the color image does not include any part that is recognizable when in color but will become difficult or impossible to recognize when outputted in monochrome.

Although in the above-mentioned embodiment the area the background color of which is to be changed is designated in the color image and the background color of the area in the monochrome image is changed, the MFP 1 may be modified such that the area can be designated either in the color image or in the monochrome image. That is, it may be arranged such that the cursor 54 is placed in the area the background color of which is to be changed, in one of the color image and the monochrome image, and the background color of the area is changed only in the monochrome image.

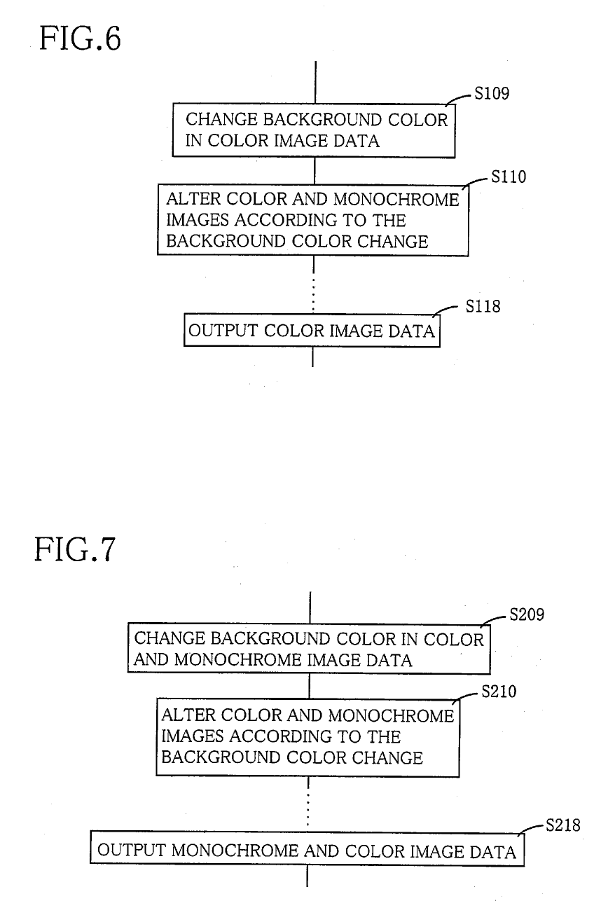

Next, there will be described a MFP according to a second embodiment of the invention, by referring to FIG. 6. The second embodiment differs from the first embodiment in that the facsimile machine that receives image data from the MFP 1 is one that can receive color image data as well as monochrome image data, and can print out a monochrome image on the basis of received color image data. The MFP of the second embodiment implements an image processing that only partly differs from the processing illustrated in FIGS. 5A-5C. The different part is illustrated in FIG. 6.

In the image processing implemented by the MFP of the second embodiment, steps S1-S8 are identical with those steps in the first embodiment. When an affirmative decision (YES) is obtained (i.e., an enter key 40c is manipulated to input an instruction to change a background color of a part or an area in an image) in step S8, the processing flow goes to step S109 in which color image data stored in a color image memory 23a is altered such that a piece of color data constituting the designated area or background is replaced to another piece of color data representing a white color, as shown in FIG. 6. Then, the processing flow goes to step S110 in which color and monochrome images are altered accordingly. Monochrome image data is automatically altered on the basis of the changed color data and the monochrome image is displayed according to the altered monochrome image data. The processing flow then goes to step S17 in which it is determined whether an instruction to start output is inputted. When an affirmative decision (YES) is obtained (i.e., the instruction to start output is inputted) in step S17, the processing flow goes to step S118 in which the MFP starts facsimile transmission of the color image data as altered and stored in the color image memory 23a.

There will be described a MFP according to a third embodiment of the invention, by referring to FIG. 7. The third embodiment partly differs from the second embodiment, and only the different part will be described.

According to the third embodiment, steps S109, S110 and S118 in the second embodiment are replaced with steps S209, S210 and S218, respectively. That is, according to the third embodiment, upon the alteration of the color image data stored in the color image memory 23a, monochrome image data stored in the monochrome image memory 23b and corresponding to the color image data is also altered, in step S209. In the next step S210, a image and a monochrome image presented on the display screen 41 based on the color image data and the monochrome image data are altered accordingly. When an instruction to start output is inputted, both the color image data and the monochrome image data are sent out by facsimile transmission, in step S218.

The MFP of the third embodiment can also operate to alter and send only the monochrome image data, and not the color image data, in the same manner as the MFP of the first embodiment does.

In each of the first to third embodiments, the image processing is described as a processing implemented in a multifunction peripheral. However, the image processing may be employed as a processing implemented in an apparatus having a single function, such as printer or facsimile machine, or in a personal computer.

In each of the first to third embodiments, the image processing is applied to the case where the user desires to send a color image by facsimile transmission. However, the image processing may be applied to the case where a monochrome image is to be printed out on the basis of color image data, that is, by converting color image data into monochrome image data.

In the first to third embodiments, the invention is applied to the case where a letter string is put in an area solidly colored, and a background solid color of the area is changed in order to make the letter string recognizable. However, the invention may be applied to a case where when a color image including two adjacent areas of different colors is presented in monochrome, the luminances of the two adjacent areas become substantially equal and thus the two areas difficult to distinguish.

In each of the first to third embodiments, it is arranged such that when an instruction to change the background color of a designated area is inputted, the background color is changed to a predetermined color, namely, white. However, the background color may be changed to other colors than white.

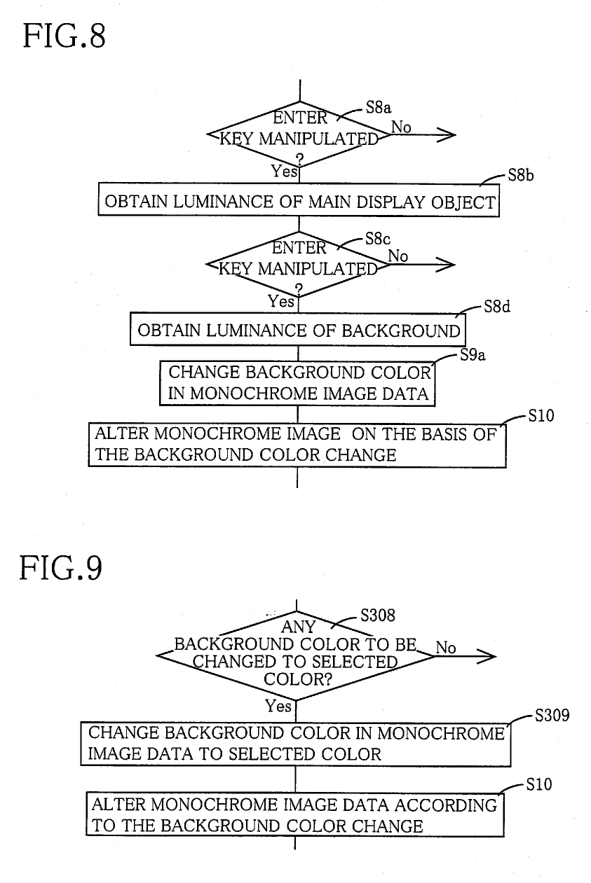

There will be described a MFP according to a fourth embodiment of the invention, by referring to FIG. 8, according to which the background color is changed to a color not white. More specifically, the luminance of a main display object, e.g., a letter or character string, is detected, and the background color of a designated area is changed to a color the luminance of which differs from that of the main display object. A flowchart according to which such an image processing is implemented is shown in FIG. 8, which shows only a part of the processing different from the processing illustrated in FIGS. 5A-5C. That is, according to the third embodiment, steps S8 and S9 in the first embodiment are replaced with steps S8a-S8d and S9a, respectively.

In the image processing implemented by the MFP of the fourth embodiment, steps S1-S7 are identical with those steps in the first embodiment. In the following step S8a, when a user manipulates a crisscross key 40a to place a cursor 54 on a main display object (e.g., letter string) and then manipulates or presses down an enter key 40c in the state where a color and a monochrome image are presented on a display screen 41, an affirmative decision is made. The processing flow then goes to step S8b in which the luminance of the main display object designated or specified by the cursor 54 is obtained. When a background of an area is designated in the following step S8c by moving the cursor 54 and manipulating the enter key 40c in the same way as in step S8a, the processing flow goes to step S8d in which the luminance of the background is obtained. Then, the processing flow goes to step S9a in which the monochrome image data is altered on the basis of the luminance values of the main display object and the background, such that a piece of color data constituting the monochrome image data and corresponding to the designated area or background is replaced with another piece of color data that makes an absolute value of the difference in luminance between the main display object and the background equal to a predetermined value. For instance, it is preset such that in principle when the luminance value of the background is higher than that of the main display object, the luminance value of the background is further increased to make the absolute value of the luminance difference equal to the predetermined value, and when the luminance value of the background is lower than that of the main display object, the luminance value of the background is further decreased to make the absolute value of the luminance difference equal to the predetermined value. In an exceptional case where it is impossible to make the absolute value of the luminance difference equal to the predetermined value even by changing the luminance of the background to an upper or a lower limit value, the luminance of the background is reversely changed, that is, when the luminance of the background is higher than that of the main display object, the luminance of the background is decreased, and when the luminance of the background is lower than that of the main display object, the luminance of the background is increased, in order to make the absolute value of the luminance difference equal to the predetermined value. Step S10 and the following steps are identical with those of the first embodiment illustrated in FIGS. 5A-5C.

There will be described a MFP according to a fifth embodiment. Unlike the MFP according to the above-described embodiments, the MFP of the fifth embodiment is arranged such that the user can specify a color to which the color of the designated area is to be changed, and the color of the designated area is changed to the specified color. A flowchart according to which the above-described image processing is implemented is shown in FIG. 9, which partly differs from the flowchart of FIGS. 5A-5C. Only the different part will be described.

In the processing of the present embodiment, steps 1-7 are identical with those steps of the first embodiment, but in the following step S308 a user selects, through a manipulation of a numeric keypad 40e, one of a plurality of colors in gradients that are preset, and presses down the enter key 40c so as to input an instruction to change the background color to the selected color. In the next step S309, monochrome image data is altered accordingly, that is, one of a plurality of pieces of color data constituting the monochrome image data and corresponding to the designated area or background is replaced with another piece of color data representative of the selected color. Step S10 and the following steps are identical with those in FIGS. 5A-5C.

In each of the above-described embodiments, the image to be outputted is of the document consisting of three pages. When the image to be outputted is of a document consisting of four or more pages, the images of the document may be presented such that the images are divided into two or more groups and images belonging to each group are presented at a time on the display screen 41. For instance, the MFP may be constructed such that the display screen 41 presents images of four pages at a time, that is, four color images and four monochrome images corresponding thereto, and the MFP provides a selector arrangement through which the user selects a desired one of the page groups so as to present images of the selected page group in thumbnail format.

Although there have been described several embodiments of the invention, it is to be understood that the invention is not limited to the details of the embodiments, but may be otherwise embodied with various modifications and improvements that may occur to those skilled in the art, without departing from the scope and spirit of the invention defined in the appended claims.

What is claimed is:

1. An image processor comprising:
a display screen;
a color image storage which stores color image data constituted by a plurality of pieces of color data;
a monochrome image storage which stores monochrome image data obtained by converting the color image data and constituted by a plurality of pieces of color data;
an image presenter which can operate to present on the display screen a color image on the basis of the color image data stored in the color image storage, and a monochrome image on the basis of the monochrome image data stored in the monochrome image storage;
an image-area designator which can designate at least a part of at least one of the color image and the monochrome image that are presented on the display screen by the image presenter;
a color-data replacer which replaces one of the pieces of color data constituting the monochrome image data and corresponding to the part designated by the image-area designator, with another piece of color data; and
an outputter which outputs the monochrome image data including the substituted piece of color data by the color-data replacer.

2. The image processor according to claim 1, wherein the image presenter comprises a screen divider which divides the display screen into a plurality of segments, and presents the color image and the monochrome image in a first one and a second one of the segments, respectively.

3. The image processor according to claim 2, wherein the first and second segments are adjacent to each other.

4. The image processor according to claim 2, wherein the display screen is rectangular and divided into two longitudinal halves that provide the first and second segments.

5. The image processor according to claim 1, wherein the image presenter comprises means for presenting on the display screen the color and monochrome images in a same size.

6. The image processor according to claim 1, wherein the color-data replacer includes a predetermining changer which replaces the piece of color data constituting the monochrome image data and corresponding to the designated part, with a predetermined piece of color data.

7. The image processor according to claim 1, further comprising a color selector by manipulation of which a user can select a piece of color data with which the color data constituting the monochrome image data and corresponding to the designated part is to be replaced, and wherein the color-data replacer includes a selective portion which replaces the piece of color data constituting the monochrome image data and corresponding to the designated part, with the piece of color data selected by means of the color selector.

8. The image processor according to claim 1, further comprising an automatic color determiner which automatically determines a piece of color data with which the piece of color data constituting the monochrome image data and corresponding to the designated part is to be changed, and wherein the color-data replacer includes an automatic portion which replaces the piece of color data constituting the monochrome image data and corresponding to the designated part, with the piece of color data automatically determined by the automatic color determiner.

9. The image processor according to claim 1, wherein the color-data replacer includes a background changing portion which changes a background color, which is a color of a background of a main display object, when the image-area designator designates the background.

10. The image processor according to claim 1,
wherein the color image storage can store the color image data of a respective plurality of pages, and includes a color thumbnail image storage which stores a plurality of color thumbnail image data corresponding to the respective pages,
wherein the monochrome image storage can store the monochrome image data of the respective pages, and includes a monochrome thumbnail image storage which stores a plurality of monochrome thumbnail image data corresponding to the respective pages,
wherein the image presenter can present a plurality of the color thumbnail images on the basis of the color thumbnail image data stored in the color thumbnail image storage, and a plurality of the monochrome thumbnail images on the basis of the monochrome thumbnail image data stored in the monochrome thumbnail image storage,
wherein the image-area designator includes a thumbnail-image-area designator which can designate at least a part of at least one of the color thumbnail images and the monochrome thumbnail images that are presented on the display screen by the image presenter,
and wherein the color-data replacer includes a thumbnail-associated portion which replaces the piece of color data constituting the monochrome image data and corresponding to the part designated by the thumbnail-image-area designator.

11. The image processor according to claim 1, which is disposed in a facsimile machine, and wherein the outputter includes a transmitter which sends out the monochrome image data including the substituted piece of color data, to another facsimile machine.

12. The image processor according to claim 1, which is disposed in a printer which has a printer portion which prints out an image on the basis of image data, and wherein the outputter includes a portion which outputs to the printer portion the monochrome image data including the substituted piece of color data.

13. An image processor comprising:
a display screen;
a color image storage which stores color image data constituted by a plurality of pieces of color data;
a monochrome image storage which stores monochrome image data obtained by converting the color image data and constituted by a plurality of pieces of color data;
an image presenter which can operate to present on the display screen a color image on the basis of the color image data stored in the color image storage, and a monochrome image on the basis of the monochrome image data stored in the monochrome image storage;
an image-area designator which can designate at least a part of at least one of the color image and the monochrome image that are presented on the display screen by the image presenter;
a first color-data replacer which replaces one of the pieces of color data constituting the one of the monochrome image data and the color image data and corresponding to the part designated by the image-area designator, with another piece of color data;
a second color-data replacer which replaces one of the pieces of color data constituting the other of the monochrome image and the color image and corresponding to the designated part, upon the replacement of the piece of color data by the first color-data replacer; and
an outputter which outputs at least one of the image data which includes the piece of color data substituted by the first color-data replacer, and the image data which includes the piece of color data substituted by the second color-data replacer.

14. The image processor according to claim 13, wherein the image presenter comprises a screen divider which divides the display screen into a plurality of segments, and presents the color image and the monochrome image in a first one and a second one of the segments, respectively.

15. The image processor according to claim 14, wherein the first and second segments are adjacent to each other.

16. The image processor according to claim 14, wherein the display screen is rectangular and divided into two longitudinal halves that provide the first and second segments.

17. The image processor according to claim 13, wherein the first color-data replacer includes a predetermining changer which replaces the piece of color data constituting the one of the color and monochrome images and corresponding to the designated part, with a predetermined piece of color data.

18. The image processor according to claim 13, further comprising a color selector by manipulation of which a user can select a piece of color data with which the color data constituting the one of the color and monochrome images and corresponding to the designated part is to be replaced, and wherein the first color-data replacer includes a selective portion which replaces the piece of color data constituting the one of the color and monochrome images and corresponding to the designated part, with the piece of color data selected by means of the color selector.

19. The image processor according to claim 13, further comprising an automatic color determiner which automatically determines a piece of color data with which the piece of color data constituting the one of the color and monochrome images and corresponding to the designated part is to be changed, and wherein the first color-data replacer includes an automatic portion which replaces the piece of color data constituting the one of the color and monochrome images and corresponding to the designated part, with the piece of color data automatically determined by the automatic color determiner.

20. The image processor according to claim 13, wherein the image presenter comprises means for presenting on the display screen the color and monochrome images in a same size.

21. The image processor according to claim 13, wherein the first color-data replacer includes a first background changing portion which changes a background color, which is a color of a background of a main display object in the one of the color and monochrome images, when the image-area designator designates the background, and the second color-data replacer includes a second background changing portion which changes a background color of the background in the other of the color and monochrome images and corresponding to the background the color of which is changed by the first background changing portion of the first color-data replacer, upon the change of the background color by the first background changing portion of the first color-data replacer.

22. The image processor according to claim 13,
wherein the color image storage can store the color image data of a plurality of pages, and includes a color thumbnail image storage which stores a plurality of color thumbnail image data corresponding to the respective pages,
wherein the monochrome image storage can store the monochrome image data of the respective pages, and includes a monochrome thumbnail image storage which stores a plurality of monochrome thumbnail image data corresponding to the respective pages,
wherein the image presenter can present a plurality of the color thumbnail images on the basis of the color thumbnail image data stored in the color thumbnail image storage, and a plurality of the monochrome thumbnail images on the basis of the monochrome thumbnail image data stored in the monochrome thumbnail image storage,
wherein the image-area designator includes a thumbnail-image-area designator which can designate at least a part of at least one of the color thumbnail image and the monochrome thumbnail image of one of the pages that are presented on the display screen by the image presenter,
wherein the first color-data replacer includes a first thumbnail-associated portion which replaces one of the pieces of color data constituting the one of the color thumbnail image and the monochrome thumbnail image and corresponding to the part designated by the thumbnail-image-area designator, and replaces one of the pieces of color data constituting one of the color image and the monochrome image of the page and corresponding to the designated part,
and wherein the second color-data replacer includes a second thumbnail-associated portion which replaces one of the pieces of color data constituting the other of the color thumbnail image and the monochrome thumbnail image and corresponding to the designated part, and replaces one of the pieces of color data constituting the other of the color image and the monochrome image of the page and corresponding to the designated part, upon the replacement of the piece of color data by the first thumbnail-associated portion of the first color-data replacer.

23. The image processor according to claim 13, which is disposed in a facsimile machine, and wherein the outputter includes a transmitter which sends out at least one of the color image data and the monochrome image data each of which includes the substituted piece of color data, to another facsimile machine.

24. The image processor according to claim 13, which is disposed in a printer which has a printer portion which prints out an image on the basis of image data, and wherein the outputter includes a portion which outputs to the printer portion the monochrome image data including the substituted piece of color data.
